(19) United States
(12) Patent Application Publication
(10) Pub. No.: US 2004/0191555 A1
(43) Pub. Date: Sep. 30, 2004

(54) Coating systems having an anti-corrosion layer and a powder coating layer

(75) Inventor: Victor V. Germano, Mentor, OH (US)

Correspondence Address: Richard J. Minnich, Esq., Fay, Sharpe, Fagan, Minnich & McKee, LLP, 1100 Superior Avenue, Seventh Floor, Cleveland, OH, 44114-2579, US

(73) Assignee: Metal Coatings International Inc.

(21) Appl. No.: 10/772,622

(22) Filed: Feb. 5, 2004

Related U.S. Application Data
(60) Provisional application No. 60/445,593, filed on Feb. 6, 2003.

(51) Int. Cl. B32B 15/02

(52) U.S. Cl. 428/553; 428/328; 428/327

(57) ABSTRACT

A coating system is disclosed that comprises a corrosion inhibiting layer and a layer formed from a powder coating composition. The layer formed from the powder coating composition is a top coating layer and the corrosion inhibiting layer is an undercoating layer. These layers, along with one or more other optional layers, form the coating system. The resulting coating system has been found to provide improved corrosion inhibiting properties and excellent bonding characteristics

### CROSS-REFERENCE TO RELATED APPLICATIONS

This application claims priority of U.S. provisional patent application Serial No. 60/445,593, filed Feb. 6, 2003.

### FIELD OF THE INVENTION

The present invention relates to coating systems for metal substrates. The coating systems feature a corrosion inhibiting coating as an undercoating and a layer formed from a powder coating that can be deposited on the corrosion inhibiting coating.

### BACKGROUND OF THE INVENTION

Powder coating technology is used for the coating of small objects, such as garden furniture, camping articles, household appliances, small automotive parts, refrigerators and shelves, and in the coating of workpieces with a complicated shape. For the most part, this technology is used for the coating of metallic components, but it is also possible, for example, to coat plastics using powder coating technology.

Generally, a powder coating process involves applying an effective amount of a powder coating on the object to be coated and then fusing the powder particles to form a continuous and integrated coating. Fusing is typically performed by subjecting the coated object to elevated temperatures.

Powder coatings can be formed upon a wide array of surfaces. Metal surfaces are the most common. Powder coatings may also be formed upon coated metal surfaces or metal surfaces resulting from various treatments.

An example of a treated metal surface onto which powder coatings have been deposited is phosphate coated steel. It has been found that certain phosphate coatings applied to a steel surface, inhibit corrosion of the underlying steel. A wide array of phosphate conversion coating compositions are known and commercially available. Bonderite® 1000 is available from Henkel Corporation and is an iron phosphate conversion coating designed for steel surfaces. The resulting phosphate-based coating is described as providing a corrosion inhibiting base for paint or other subsequent coatings.

It is known to form a powder coating top coat upon such phosphate coated steel substrates. Similar coating systems are known for zinc substrates. Aluminum substrates may utilize a chromate conversion coating that forms a chromate-based coating. It is known to form a powder coating layer on the chromate coating. Each of these multi-layer and multi-component coating systems is described in Akzo Nobel's “Concise Guide to Powder Coatings,” Issue 1, Apr. 1999.

Prior artisans have investigated the specific combination of corrosion-inhibiting conversion layers formed on metal substrates as a pretreatment for a subsequent powder coating. In U.S. Pat. No. 5,294,266, Hauffe et al. described treating phosphate layers formed on metals, particularly steel, zinc, aluminum, and alloys thereof, prior to depositing a powder coating thereon. And, in U.S. Pat. No. 6,105,233, Neal described applying a zinc-chromate coating onto a steel component by first applying an initial zinc coating to the steel surface and then immersing the coated component in a chromate conversion formulation. The resulting coating is said to be a “zinc-chromate” coating. After formation of that coating, a powder coating outer layer is deposited thereon.

Although satisfactory in many respects, there are several disadvantages of currently known multi-layer coating systems of these types. Chromate-based coatings are subject to stringent environmental regulations and costly to process. Therefore, there is a need for a chromate-free coating system that provides a corrosion inhibiting coating and an outer powder coating layer. Phosphate-based coatings, although quite popular, do not always provide the necessary long term corrosion protection or adhesion and bond between the underlying metal surface and an adjacent layer of a powder coating. Accordingly, there is a need for an improved coating system, and preferably one which provides both good bonding characteristics, and long term corrosion protection.

### SUMMARY OF THE INVENTION

In a first aspect, the present invention provides an anti-corrosion coating system comprising a first layer formed from a corrosion inhibiting composition comprising particulate metal, organic liquid, thickener, and a silane binding agent. The coating system also comprises a second layer disposed on the first layer in which the second layer is formed from a powder coat composition.

In another aspect, the present invention provides an anti-corrosion coating system comprising a first layer formed from a composition including zinc flakes and aluminum flakes dispersed in a binder. The anti-corrosion coating system also comprises a second layer disposed on the first layer in which the second layer is formed from a powder coat composition.

In yet another aspect, the present invention provides an anti-corrosion coating system comprising a first layer formed from a composition comprising zinc alloy in particulate form comprising greater than 50 weight percent zinc and less than 50 weight percent of non-zinc alloy metal. The anti-corrosion coating system also comprises a second layer disposed on the first layer. The second layer is formed from a powder coat composition.

In still a further aspect, the present invention provides an anti-corrosion coating system comprising a first layer formed from a composition comprising a liquid medium, zinc alloy in particulate form comprising greater than 50 weight percent zinc and less than 50 weight percent of non-zinc alloy metal, and a silane binding agent. The anti-corrosion coating system also comprises a second layer disposed on the first layer. The second layer is formed from a powder coat composition.

In yet another aspect, the present invention provides an anti-corrosion coating system comprising a first layer formed from a composition comprising liquid medium, zinc alloy in particulate form comprising greater than 50 weight percent zinc and less than 50 weight percent of non-zinc alloy metal, and one or more of a water soluble and water dispersible silica substance. The anti-corrosion coating system also comprises a second layer disposed on the first layer. The second layer is formed from a powder coat composition.

### DESCRIPTION OF THE PREFERRED EMBODIMENTS

The present invention provides a unique multi-layer coating system that provides excellent corrosion resistance and durability for metal substrates. The preferred embodiment coating system comprises one or more layers of a corrosion inhibiting composition as described herein, and one or more layers of a powder coating disposed on the layer of corrosion inhibitor. The preferred powder coatings are described herein. The resulting coating system provides excellent protection against corrosion, outdoor exposure and resistance to weathering in conjunction with also providing, attractive appearance and aesthetics.

A wide array of corrosion inhibitor compositions and formulations may be used in the present invention coating system. Generally, the corrosion inhibitor composition is adapted for application to zinc, aluminum, magnesium, or manganese, although a variety of other metals are included such as iron, steel, and steel alloys.

A preferred corrosion inhibiting composition for use in the present invention multi-layer coating system, comprises particulate metal, water, thickener, and silane binding agent. A high boiling organic liquid may also be optionally used.

The particulate metal of the coating composition can, in general, be any metallic pigment such as finely divided aluminum, manganese, cadmium, nickel, stainless steel, tin, ferroalloys, magnesium or zinc. The particulate metal is most preferably zinc dust or zinc flake or aluminum dust or aluminum flake. The particulate metal may be a mixture of any of the foregoing, as well as comprise alloys and intermetallic mixtures thereof. Flake may be blended with pulverulent metal powder, but typically with only minor amounts of powder. The metallic powders typically have particle size such that all particles pass 100 mesh and a major amount pass 325 mesh (“mesh” as used herein is U.S. standard Sieve Series). The powders are generally spherical as opposed to the leafing characteristic of the flake.

Where there is combined in the composition particulate zinc with aluminum, the aluminum may be present in very minor amount, e.g., from as little as about 2 to about 5 weight percent, of the particulate metal, and still provide a coating of bright appearance. Usually the aluminum will contribute at least about 10 weight percent of the particulate metal. Thus, frequently, the weight ratio of aluminum to zinc in such a combination is at least about 1:9. On the other hand, for economy, the aluminum will not contribute more than about 50 weight percent of the zinc and aluminum total, so that the aluminum to zinc weight ratio can reach 1:1. The particulate metal content of the coating composition will not exceed more than about 35 weight percent of the total composition weight to maintain best coating appearance, but will usually contribute at least about 10 weight percent to consistently achieve a desirable bright coating appearance. Advantageously, where aluminum is present, and especially where it is present without other particulate metal, the aluminum will provide from about 1.5 to about 35 weight percent of the total composition weight. Typically, when particulate zinc is present in the composition, it will provide from about 10 to about 35 weight percent of the total composition weight. As has been discussed hereinbefore, particularly where the metal has been prepared in flake form in liquid medium, the metal can contribute some liquid in minor amount, e.g., dipropylene glycol or mineral spirits, or some liquid even in trace amount. Particulate metals contributing liquid are usually utilized as pastes, and these pastes can be used directly with other composition ingredients. However, it is to be understood that the particulate metals may also be employed in dry form in the coating composition.

The high-boiling organic liquid that may optionally be used in the coating composition liquid medium should have a boiling point at atmospheric pressure above about 100° C., while preferably being water soluble. Useful organic liquids contain carbon, oxygen and hydrogen and have at least one oxygen-containing constituent that may be hydroxyl, or oxo, or a low molecular weight ether group, i.e., a C₁-C₄ ether group, so that for convenience such liquids can be referred to as “oxohydroxy liquids.” Since water dispersibility and preferably water solubility is sought, high molecular weight polymeric hydrocarbons are not particularly suitable, and advantageously serviceable hydrocarbons contain less than about 15 carbon atoms and have a molecular weight of 400 or less.

Particular hydrocarbons which may make up the high-boiling organic liquid include tri- and tetraethylene glycol, di- and tripropylene glycol, the monomethyl, dimethyl, and ethyl ethers of these glycols, low molecular weight liquid polypropylene glycols, as well as diacetone alcohol, the low molecular weight ethers of diethylene glycol, and mixtures of the foregoing. Usually, the organic liquid will be present in an amount from about 1 to about 30 weight percent, basis total composition weight. Presence of the organic liquid, particularly in amounts above about 10 weight percent, e.g., at 15 to 25 weight percent, can enhance the corrosion-resistance of the coating, but use of greater than about 30 weight percent can become uneconomical. For economy, ease of composition preparation, and for reduced volatile constituents in the composition, dipropylene glycol is preferred and is preferably present in an amount between about 1 to 4 weight percent of the total composition. It is to be understood that the organic liquid is typically provided to the composition as a separate component, but that some to all of the liquid may be introduced in another manner. Where metal particles have been prepared as metal flake in organic liquid medium, the resulting particulate metal may be in paste form. Where such paste form metal is used, it can provide some portion to all of the organic liquid to the coating composition. For example, aluminum flake paste can be 25 weight percent diproplyene glycol and readily contribute one weight percent of such glycol to the overall composition. For contributing particulate aluminum, the use of aluminum flake paste can be economical. Hence, for economy, those compositions which contain aluminum flakes can be expected to have a combination liquid medium of water plus high-boiling organic liquid.

The organic liquid of the coating composition liquid medium is a low-boiling organic liquid, although there may be present some high-boiling organic liquids, so that the liquid medium may include mixtures of the foregoing. It was previously considered that serviceable compositions should contain high-boiling organic liquid as an important ingredient. Such was disclosed in U.S. Pat. No. 5,868,819. Suitable coating compositions can also be produced that contain low-boiling organic liquid, while retaining desirable composition characteristics, such as composition stability. The low-boiling organic liquids have a boiling point at atmospheric pressure below about 100° C., and are preferably water-soluble. Such may be represented by acetone, or low molecular weight alcohols such as methanol, ethanol, n-propylalcohol and isopropylalcohol, and further include ketones that boil below 100° C., such as water-soluble ketones, e.g., methyl ethyl ketone.

It is contemplated that the coating composition will typically contain thickener. This will be between about 0.05 to about 2.0 weight percent of thickener. This can be a water-soluble cellulose ether, including the “Cellosize™” thickeners. Suitable thickeners include the ethers of hydroxyethylcellulose, methylcellulose, methylhydroxypropylcellulose, ethyl-hydroxyethylcellulose, methylethylcellulose or mixtures of these substances. Although the cellulose ether needs to be water soluble to augment thickening of the coating composition, it need not be soluble in the high-boiling organic liquid. Less than about 0.05 weight percent of the thickener will be insufficient for imparting composition thickness, while greater than about 2 weight percent of thickener in the composition can lead to elevated viscosities which provide compositions that are difficult to work with. Preferably, for the best thickening without deleterious elevated viscosity, the total composition will contain from about 0.2 to about 1.2 weight percent of thickener. It will be understood that although the use of a cellulosic thickener is contemplated, and thus the thickener may be referred to herein as cellulosic thickener, some to all of the thickener may be another thickener ingredient. Such other thickening agents include xanthan gum, associative thickeners, such as the urethane associative thickeners and urethane-free non-ionic associative thickeners, which are typically opaque, high-boiling liquids, e.g., boiling above 100° C. Other suitable thickeners include modified clays such as highly beneficiated hectorite clay and organically modified and activated smectite clay, although such is not preferred. When thickener is used, it is usually the last ingredient added to the formulation.

The silane binding agent is preferably a water-reducible, organofunctional silane. The organofunctionality can be represented by vinyl, methacryloxy and amino, but is preferably epoxy functional for enhanced coating performance as well as composition stability. The agent generally contains the —Si(OCH₃)₃ functionality. Preferably, the useful silane is an epoxy functional silane such as beta-(3,4-epoxycyclohexyl) ethyltrimethoxysilane, 4(trimethoxysilyl) butane-1,2 epoxide or gamma-glycidoxypropyltrimethyoxysilane. Additional details concerning the silane binding agent are set forth below.

The present invention coating systems may also utilize a corrosion inhibitor composition based upon flakes or particles of a zinc alloy dispersed in a suitable binder. The preferred particulate metal is an alloy of zinc in flake or other particulate form generally comprising at least greater than 50 weight percent zinc. The balance of the alloy is thus less than 50 weight percent of non-zinc alloy metal. For a zinc/aluminum alloy the zinc advantageously comprises greater than about 80 weight percent zinc, metals basis, or, conversely, less than about 20 weight percent aluminum, and preferably greater than about 85 weight percent zinc, or less than about 15 weight percent aluminum. For a zinc/tin alloy, on a metals basis, there is advantageously at least about 70 weight percent of zinc or, conversely, not more than about 30 weight percent tin. For considering corrosion resistance of a coated substrate, the alloy is preferably an alloy of zinc and aluminum in flake form.

Preferably, for economy of alloy production, the zinc alloy will be in flake form in a paste. In the alloy of zinc with aluminum in a paste, the aluminum may most advantageously be present in an amount up to about 8 weight percent, basis weight of the paste. For corrosion resistance of the coating balanced with coating adhesion, the aluminum will preferably not contribute more than about 5 weight percent, basis weight of the paste. The total of the zinc alloy flake will generally contribute from 90 to 95 weight percent or more of the paste, with a balance of paste liquid. The alloy flake paste can contribute some liquid in minor amount, e.g., dipropylene glycol or mineral spirits, or some liquid even in trace amount to the coating composition. It has been found that the zinc alloy flake paste can be generally useful, together with other coating composition ingredients, for those coating compositions that will contain particulate metal in paste form. It is also contemplated that the special alloy flake can be useful when prepared in dry form. Such dry form paste can thus be 99 weight percent or more of alloy flake.

Zinc alloys in flake form other than the zinc and aluminum alloy, or zinc and tin alloy, can be useful. These include zinc alloyed with one or more of magnesium, nickel, cobalt and manganese. A representative three-metal alloy flake is zinc-aluminum-magnesium alloy. The preferred alloy paste for use in the corrosion inhibiting composition is STAPA 4ZnAI7 made by Eckart-Werke, which is a paste of zinc and aluminum alloy in flake form typically containing from about 85 to about 86 weight percent zinc, from about 4 to about 8 weight percent aluminum and a balance of from about 7 to about 10 weight percent paste liquid, all basis 100 weight percent of the paste. Such a paste containing from about 4 to about 5 weight percent of aluminum in the alloy is also of particular interest. With regard to particle size, the preferred alloy flake of zinc and aluminum will generally have a size such that at least about 50 weight percent of the flake particles will have a maximum dimension of less than about 13 microns, and preferably has at least about 90 weight percent of the particles with a maximum dimension of less than about 15 microns. For convenience, the non-alloy balance of the paste, i.e., the about 7 to about 10 weight percent balance, is referred to herein for convenience as the paste liquid. It will, however, be understood that this balance may contain substituents, e.g., lubricants used in making the paste, that are not in liquid form when the paste is utilized in the coating composition.

It is to be understood that the zinc alloy flake may be present in a coating composition with other pulverulent metal, which is in non-flake form, e.g., zinc, aluminum, aluminum alloy, or mixtures thereof in pulverulent, non-flake form. Thus, this pulverulent metal in non-flake form may also be in non-alloy form. Such metal in other form may be incorporated with the paste, but more typically will be blended into the coating composition generally, although it could be used in both. Typically only minor amounts of such other pulverulent metal, in non-flake form, will be present in the coating composition, and the incorporation of such other metal is often avoided. Usually, the non-flake metal might be in powder form.

Although it is contemplated that the zinc alloy flake will be useful in any coating composition wherein particulate metal is utilized in a liquid vehicle (or “liquid medium” as such term is used herein) to prepare a corrosion-resistant coating, several compositions are of particular interest.

In addition to the particulate metal and the liquid medium, another necessary ingredient in these compositions is silane, sometimes referred to herein as the “silane binding agent.” For the preferred corrosion inhibiting compositions, these can include water-reducible, organofunctional silane. To be water-reducible, the silane should be readily dilutable with water and is preferably completely dilutable with water. The useful silane for other than the preferred compositions can be one where the silane must have a co-solvent present when reduced with water, so as to prevent gellation on water reduction, or to prevent the formation of a precipitate. For example, silanes such as the organotrigydrocarbonoxy silanes of U.S. Pat. No. 4,218,354, herein incorporated by reference, and as represented by methyltriethoxy silane, are useful for other than the preferred water-reducible compositions. These silanes must be blended with a co-solvent and water, e.g., ethylene glycol monoethyl ether and water. For these silanes, the silane and water react such that without the co-solvent, fast gellation would be typical. In this regard, the silanes which are useful herein in the preferred compositions are non-gelling, water-reducible silanes. These silanes will generally contribute from about 3 weight percent to about 20 weight percent of the total composition weight. In these silanes, the organofunctionality can be represented by vinyl, e.g., as in vinyltrimethoxysilane, or methacryloxy, such as in methacryloxypropyl-trimethoxysilane, and amino, as in 3-amino-propyltrimethoxysilane, but is preferably epoxy functional for enhanced coating performance as well as composition stability. As previously noted, these generally contain the —Si(OCH₃)₃ or —Si(OCH₂CH₂CH₃)₃ functionality. Preferably, the useful silane in the preferred water-reducible composition is an epoxy functional silane such as beta-(3,4-epoxycyclohexyl) ethyltrimethoxy-silane, 4(trimethoxysilyl) butane-1,2 epoxide or gamma-glycidoxypropyltrimethoxysilane.

A typical coating of this type includes the zinc alloy metal flake and a silica substance constituent, sometimes referred to herein as a silica substance “binder” such as sodium silicate. The water-soluble or water dispersible binder may also more broadly be an alkali metal silicate, an organic silicate ester, e.g., ethyl silicate, a colloidal silica sol or the like. Further, organic ammonium silicates have been disclosed as binders. The use of ethyl silicate or the like has been disclosed in U.S. Pat. No. 3,469,071 and the utilization of an organic ammonium silicate has been disclosed in U.S. Pat. No. 3,372,038. The disclosures of these two patents are hereby incorporated by reference.

The assignee of the present invention offers several commercially available corrosion-resistant compositions under the trademarks Dacromet® and Geomet®. These compositions are preferred for use in the multi-layer coating systems of the present invention. Dacromet® is an inorganic coating based upon zinc and aluminum flakes in an inorganic binder. Specific grades of Dacromet® include Dacromet 320® which contains low volatile organic compounds (VOCs); Dacromet 320 LC® which is a low chromium formulation; Dacromet 500® which is based upon the use of polytetrafluorethylene to provide consistent torque-tension characteristics; and Dacromet 320® HS which is formulated to provide a relatively thick and heavy coating. Geomet® is an aqueous coating dispersion containing zinc and aluminum flakes, with an inorganic binder system. Geomet® was formulated as an alternative, environmentally friendly corrosion-resistant coating. Geomete® is water-based, low in VOCs, and can be free of all highly regulated toxic metals including chromium, nickel, cadmium, barium and lead. It is also significant that Geomet® products are phosphate-free. This may be of particular importance for uses of the present invention coating system in phosphate-free applications. Dacromet® and Geomet® products are available from Metal Coatings International, Inc., Chardon, Ohio, and also through numerous licensees thereof. Further descriptions of corrosion-inhibiting coatings are described in U.S. Pat. Nos. 3,907,608; 4,555,445; 4,645,790; 4,891,268; 4,799,959; 5,006,597; 5,868,819; 6,270,884; and 6,361,872; all of which are hereby incorporated by reference.

Although a wide array of corrosion inhibiting compositions may be used in the present invention coating system, it is generally preferred that the corrosion inhibiting composition be water-based. Accordingly, it is generally preferred that such composition be selected from the Geomet® class of compositions.

Powder coating compositions are based on both thermoplastic and thermosetting resins. These resins are incorporated in the powder coat composition and are in particulate form. The particles of polymeric resin are generally dispersed within a suitable binder as known in the art. For use as a powder coating, a resin should possess certain characteristics such as low melt viscosity, which affords a smooth continuous film; good adhesion to the substrate; good physical properties when properly cured, e.g. high toughness and impact resistance; good heat and chemical resistance; and good weathering resistance. The resin should remain stable on storage at about 25° C. for at least six months and should possess a sufficiently high glass-transition temperature, T_{g}, so as to resist sintering on storage.

As a coating powder, a thermoplastic resin must melt and flow at the application temperature without significant degradation. Efforts to improve the melt flow characteristics of a polymer by lowering the molecular weight and plasticizing or blending with a compatible resin of lower molecular weight can result in poor impact resistance or a soft film in the applied coating. Efforts to improve the melt flow by increasing the application temperature are limited by the heat stability of the polymer. If the application temperature is too high, the coating exhibits a significant color change or evidence of heat degradation. Most thermoplastic powder coatings are applied between about 200 and 300° C., well above the generally considered upper temperature limits, but the application time is usually less than about 5 minutes. The preferred polymer types are based on plasticized poly(vinyl chloride) (PVC), polyamides, polyethylenes, polypropylenes, poly(vinylidene) fluorides, and other specialty thermoplastics. Typical properties of preferred thermoplastic coating powders are given in Table 1, set forth below.

TABLE 1
Physical and Coating Properties of Thermoplastic Powders

| Property | Vinyls | Polyamides | Polyethylene | Polypropylene | PVDF^{a} |
|---|---|---|---|---|---|
| melting point, ° C. | 130-150 | 186 | 120-130 | 165-170 | 170 |
| preheat/postheat | 290-230 | 310-250 | 230-200 | 250-220 | 230-250 |
| temperatures, ° C. | | | | | |
| specific gravity | 1.20-1.35 | 1.01-1.15 | 0.91-1.00 | 0.90-1.02 | 1.75-1.90 |
| surface appearance | smooth | smooth | orange-peel | smooth | slight |
| | | | effect | | orange- |
| | | | | | peel effect |
| gloss, Gardner 60° | 40-90 | 20-95 | 60-80 | 60-80 | 60-80 |
| meter | | | | | |
| hardness, Shore D | 30-55 | 70-80 | 30-50 | 40-60 | 70-80 |
| resistance | | | | | |
| impact | excellent | excellent | good to | good | good |
| | | | excellent | | |
| salt spray | good | excellent | fair to good | good | good |
| weathering | good | good | poor | poor | excellent |
| humidity | excellent | excellent | good | excellent | good |
| acid | excellent | fair | excellent | excellent | excellent |
| alkali | excellent | excellent | excellent | excellent | good |
| solvent | fair | excellent | good | excellent | good to |
| | | | | | excellent |

^{a}Poly(vinylidene fluoride).

All PVC powder coatings are generally plasticized formulations. Without plasticizers, PVC resin is too high in melt viscosity and does not flow sufficiently under the influence of heat to form a continuous film. Suspension and bulk polymerized PVC homopolymer resins are used almost exclusively in powder coatings since vinyl chloride-vinyl acetate and other copolymer resins have insufficient heat stability. A typical melt-mixed PVC powder coating formulation is given in Table 2, provided below. The dispersion-grade PVC resin is added in a post-blending operation to provide beneficial fluidizing characteristics. Whereas most PVC powder coatings are made by a dry-blend process, melt-mixed formulations are used where superior performance, such as in outdoor weathering applications and electrical insulation, is required.

TABLE 2
Melt-Mixed PVC Coating Powder Formulation

Composition

| Ingredient | Parts by weight | Wt % |
|---|---|---|
| PVC homopolymer resin | 100 | 47.8 |
| DNODP^{a} | 65 | 31.1 |
| epoxidized soya oil | 5 | 2.4 |
| TiO₂/CaCO₃^{b} | 25 | 12.0 |
| stabilizers | | |
| barium-cadmium | 6 | 2.9 |
| organic phosphite | 3 | 1.4 |
| dispersion-grade PVC | 5 | 2.4 |
| Total | 209 | 100.0 |

^{a}n-Octyl n-decyl phthalate, C₂₆H₄₂O₄.
^{b}Pigment/extender

Thermoplastic coating powders based on polyamide resins have been previously used in fusion-coating processes. Nylon-11 has been used almost exclusively. However, more recently, coating powders also have been utilized based on nylon-12. The properties of these two resins are quite similar. Nylon-6 and nylon-6,6 are generally not used because their melt viscosities are too high.

Polyamide powders are typically prepared by both a melt-mixed and dry-blend process. In the latter, the resin is ground to a fine powder and the pigments are mixed in using a high intensity mixer. Melt-mixed powders have a higher gloss, e.g., about 70-90% on the Gardner 60° glossmeter, whereas dry-blended powders have a gloss in the range of about 40-70%. Because the pigment is not dispersed in the resin in the dry-blend process, it must be used at very low concentrations, usually less than 5%. Even in melt-mixed formulations, the concentration of pigment and fillers seldom exceeds about 30%.

Thermoplastic coating powders based on polyethylene and polypropylene have been available for many years but have achieved limited commercial success. A primary problem in using polyolefin-based coating powders is poor adhesion to metal or a metallic coating. Modified polyolefin powders have been disclosed in the art in which an unsaturated carboxylic acid or anhydride is grafted onto the polyolefin resin backbone, along with other modifiers to improve adhesion. Also, multilayer coatings having an intermediate layer of epoxy resin and modified polyolefins have also been developed.

Architectural coatings based on poly(vinylidene fluoride) (PVDF) and applied as dispersions in organic solvents have been available and used successfully for many years. Because of the significant reduction in volatile organic compounds (VOCs) mandated by recent legislation, efforts have been made to develop coating powders based on PVDF resins. Thermoplastic acrylic polymers are used as a modifying resin to improve flow, pigment wetting, and adhesion. Thermosetting coating powders based on hydroxy functional fluoropolymer resins cross-linked with blocked isocyanates have also been disclosed.

Several other thermoplastic coating powders are available. These powders are based on specialty polymers such as ethylene-chlorotrifluoroethylene (E-CTFE), poly(phenylene sulfide) (PPS), and tetrafluoroethylene-ethylene copolymers. Such powders are used in functional applications where resistance to corrosion and elevated temperatures are required.

Thermosetting coating powders, with minor exceptions, are based on resins that cure by addition reactions. Thermosetting resins are more versatile than thermoplastic resins. Many types of such resins are available both in varying molecular-weight ranges and having different functional groups. Numerous cross-linking agents are available. And so, the properties of the applied film can be modified. Additionally, the resins possess a low melt viscosity during application allowing formation of thin films. And addition of pigments and fillers required to achieve opacity in the thin films can be incorporated without adversely affecting flow. Furthermore, gloss, textures, and special effects can be produced by modifying the curing mechanism or through the use of additives. Moreover, manufacturing costs of such resins are generally less because compounding is carried out at lower temperatures and the resins are friable and can be ground to a fine powder without using cryogenic techniques.

The properties of several preferred thermosetting coating powders are given in Table 3, below. The molecular weight, or the glass-transition temperature, T_{g}, of coating powder thermosetting resins must be high enough to prevent the individual particles from sintering or fusing during transportation and storage. The minimum T_{g} required is in the range of about 40-50° C. and preferably above 50° C. Epoxy resins, because of their aromatic backbone, have the required T_{g} at relatively low molecular weight and corresponding low melt viscosity. Other thermosetting resins, however, require some linear comonomers to achieve flexibility. This results in a lower T_{g} and higher molecular-weight resins should be used. Thus, at an equivalent range of T_{g}, polyester resins have a melt viscosity of about 4000 to about 9000 mPa·s (e.g. cP) at 200° C. or about 2 to about 10 times that of an epoxy resin. As pigment and filler loadings are increased, the difference in flow becomes even more pronounced. Therefore, considerable efforts have been made to develop resins that provide a smooth finish, and good storage stability, physical properties, and cure response.

TABLE 3
Physical and Coating Properties of Thermosetting Powders

| Property | Epoxy | Polyurethane^{a} | Polyester^{b} | Hybrid | Acrylic^{a} |
|---|---|---|---|---|---|
| fusion range, ° C. | 120-200 | 160-220 | 160-220 | 140-210 | 120-200 |
| cure time^{c}, min | 1-30^{d} | 5-15 | 5-15 | 5-15 | 5-15 |
| storage temp, ° C.^{e} | 30 | 30 | 30 | 30 | 30 |
| gloss. Gardmer 60° | 5-95 | 5-95 | 40-95 | 20-95 | 80-95 |
| meter | | | | | |
| pencil hardness^{f} | H-4H | H-2H | H-4H | H-2H | H-2H |
| flexibility | excellent | excellent | excellent | excellent | excellent |
| resistance | | | | | |
| impact | excellent | good to | good to | good to | good to |
| | | excellent | excellent | excellent | excellent |
| overbake | fair to poor | good to | excellent | good to | good |
| | | excellent | | excellent | |
| weathering | poor | good to | good to | poor to | good to |
| | | excellent | excellent | fair | excellent |
| acid | good to | fair | good | good | fair |
| | excellent | | | | |
| alkali | good to | poor | fair | good | poor |
| | excellent | | | | |
| solvent | good to | fair | fair to good | fair | fair |
| | excellent | | | | |

^{a}Hydroxy function-blocked isocyanate cure.
^{b}TGIC (triglycyl isocyanurate) cure.
^{c}Value is given at 160-200° C., unless otherwise indicated.
^{d}At 240-135° C.
^{e}Maximum value is given.
^{f}Refers to highest degree of lead hardness at which coating can be marred.

In addition to resin and curing agents or hardeners, a variety of other. ingredients are typically used in coating powder formulations. Catalysts and accelerators are used to modify the reaction rate and curing characteristics. Flow control additives are employed to prevent cratering and promote leveling of the molten polymer film and wetting of the substrate. The most widely used types are low molecular-weight polymers of butyl acrylate and copolymers of ethyl acrylate and 2-ethylhexyl acrylate. Thermoplastic resins such as benzoin are sometimes used to aid the release of bubbles from the molten film.

Matting or flattening agents are employed to control gloss, which is dependent on microscopic surface smoothness. Thus, materials that disrupt surface smoothness through incompatibility, such as polypropylene, can be used to control gloss. Certain fillers such as coarse grades of calcium carbonate and various silicates are also used to modify gloss, usually in combination with other techniques. Curing agents having widely different reactivities cause a two-stage polymerization to occur, resulting in reduced gloss. Mixing powders of varying reactivities (gel time) also result in a reduction in the gloss of the final film, although this effect is not always desired.

Colorants are used in most powder coating formulations. Carbon black, titanium dioxide, iron oxides, and other inorganic pigments are widely used. Most organic pigments also are used in powder coatings. However, because of high surface area and thixotropic characteristics, organic pigments cannot be used at high, e.g., greater than about 10%, levels without giving excessive orange peel. Fillers such as calcium carbonate, blanc fixe, barium sulfate, and various silicates are used to modify gloss, hardness, permeability, and other coated film characteristics. Polyolefins, fluorocarbons, and waxes are used to modify the slip and mar characteristics of the film.

A wide array of thermoset powder coating compositions may be utilized in the present invention coating system. Preferred types of powder coating compositions include, but are not limited to epoxy coating powders, epoxy-polyester hybrid powders; polyester-TGIC powders, urethane polyester powders, unsaturated polyester resin powders, and acrylic resin powders. Each of these types of powder coatings are described in greater detail herein.

Thermosetting coating powders based on epoxy resins, C₁₅H₁₆O₂.(C₃H₅ClO)ₓ, have been used longer in powder coating processes and sold in greater volume than any other resin class. The earliest epoxy powders, based on latent curing agents such as dicyandiamide, C₂H₄N₄, frequently accelerated using tertiary amines or imidazoles, were slow to medium-fast curing having a typical cure cycle of about 20 to about 30 minutes at 200° C. With minor modifications, some of these powders are used in such applications as buss bar and motor core insulation and corrosion-resistant coatings where their excellent long-term performance has been well documented. However, the development of electrostatic spray powders led to faster curing coating powders having better flow and designed primarily for decorative applications.

Decorative epoxy powders are used in a wide variety of applications, such as for light fixtures, garden equipment, floor cleaning machines, motor control cabinets, and for automotive under-the-hood items. Resins of the “3” type, i.e., epoxide equivalent weight (EEW) of about 650 to about 750, are frequently used. Resins in this molecular weight range have the lowest melt viscosity (high flow) commensurate with a T_{g} high enough to prevent powder sintering under most conditions of storage. Type 4 epoxy resins (EEW about 750 to about 900) are more often used in functional applications such as for electrical insulation where thicker coatings are used and a higher degree of edge coverage is necessary. Even higher equivalent weight resins are sometimes used to enhance flexibility or other special requirements.

Epoxy resins react with acid functional curing agents to yield a coating having many desirable properties. For many years, coating powders based on epoxy resins cured using trimellitic anhydride (TMA) were used for both decorative and functional applications. However, as the irritant and sensitizing characteristics of TMA have become more widely recognized, this system became less popular.

A series of acid functional saturated polyester resins specifically designed for curing using bisphenol A epoxy resins is known. These resins have an acid number between about 35 and 75 (this corresponds to an acid equivalent weight of about 750 to about 1600), are relatively linear, and are used at about a 1:1 epoxy:polyester stoichiometric ratio. Properties of these polyester-epoxy hybrids are similar to those of a straight epoxy, but differ in several respects. Most epoxy curing agents contain nitrogen compounds that discolor on extended heating. Because the cross link density for hybrid coatings is generally less than for straight epoxies, hybrid coating powders are inferior in solvent resistance and hardness. They are also somewhat inferior in salt spray and corrosion resistance. Polyester resins, having a higher melt viscosity than epoxy resins, cause the hybrids to have more orange peel than epoxy formulations, especially at the higher polyester-epoxy ratios.

The reaction rate between carboxyl end groups of the polyester and the epoxide groups of the epoxy resin is generally quite slow requiring a catalyst to obtain a practical baking time. Catalysts are frequently mixed with the polyester resin by the resin manufacturer. The ideal catalyst should exhibit good reactivity at the desired baking temperature, e.g. about 140° C., while providing good flow and shelf stability. Tertiary amines, amic acids, and quaternary phosphonium compounds are effective catalysts for the epoxy-carboxyl reaction.

Epoxy-polyester hybrids are somewhat better than straight epoxies in gloss retention on exterior exposure but are not recommended for exterior applications in most cases. For the most part, applications for the hybrids are the same as those for decorative epoxies.

A principal class of exterior durable powder coatings is based on acid functional saturated polyester resins cured using triglycidylisocyanurate (TGIC). The acid functional polyester resins used in TGIC-cured coating powders are similar to those used in epoxy polyester hybrids. However, the TGIC-cured resins have a higher equivalent weight, typically in the range of about 1600 to about 1900. Therefore, most resins are used at a 93:7 ratio of resin to TGIC. Acid functional resins are normally prepared by a two-step process. The reaction of excess polyol and dibasic acids is followed by esterification of the hydroxyl terminated resin using dibasic acids or anhydrides. This technique yields a resin where the functional groups are at the end of the molecule, rather than occurring randomly along the polymer chain. It is also possible to prepare carboxyl group terminated polyesters in a one-step process. The high T_{g} resins appear to be more resistant to hydrolysis, which also contributes to film degradation on exterior exposure. Reactivity, flow, and physical properties are addressed through the use of specific catalysts and control of molecular structure.

Powder coatings based on TGIC-cured polyesters have excellent physical properties and flexibility, good resistance to color change on overbake, and a generally good over all balance of properties. However, TGIC has shown mutagenic activity. Other curing agents have been reviewed. Among the most promising are the β-hydroxyalkylamide curing agents. Since these agents and acid functional resins react via a condensation reaction, problems of surface imperfections resulting from the volatiles generated have been observed in coatings where the thickness exceeds about 75-80 μm. Coating powders based on this technology have not gained significant commercial success.

The search for exterior durable coating powders led to technologies based on hydroxyl functional polyester resins. The earliest curing agents evaluated were based on melamine-formaldehyde resins, such as hexa(methoxymethyl) melamine (HMMM), which are widely utilized as curing agents in conventional paint systems. Coating powders based on this chemistry suffer various limitations. The melamine resin depresses the T_{g} of the coating powder to the point where the powder sinters during storage, especially at elevated temperatures. And the methanol generated during curing becomes trapped in the film, especially at thicknesses above about 50 μm, resulting in a frosty or visually nonuniform surface. Curing agents based on polyisocyanates blocked with caprolactam (qv) give an outstanding combination of properties in the final film. Because the unblocking reaction does not start to occur until about 160° C., the powder has a chance to flow out and give a smooth uniform film prior to any substantial cross-linking. In addition, not all of the caprolactam present evolves during the curing reaction. Some remains in the film, apparently acting as a plasticizer so that the urethane polyesters yield a much smoother, more orange peel-free film than the TGIC polyesters.

The polyester resins used in this technology are typically based on terephthalic acid, C₈HO, or isophthalic acid, C₈H₆O₄, neopentyl glycol, C₅H₁₂O₂, and branched using trimellitic anhydride. The most commonly used curing agents are adducts of isophorone diisocyanate (IPDI), C₁₂H₁₈N₂O₂, and low molecular-weight polyols, blocked with caprolactam. Other aliphatic or cycloaliphatic isocyanate adducts blocked with caprolactam can also be used. Caprolactam blocked aromatic isocyanates such as toluene diisocyanate, C₉H₆N₂O₂, are also used, but result in coatings having limited exterior durability. Polyester resins having an acid number of 40 to about 50 (equivalent weight of about 1100 to about 1400) are mostly used, but highly branched resins of equivalent weights as low as 200 are available, which can be mixed with these resins to produce coatings having exceptionally high hardness and outstanding stain, solvent, and chemical resistance.

Environmental concerns about the caprolactam evolved from urethane polyester coating powders during curing has led to research into using higher T_{g} derivatives such as tetramethoxyglycoluril and higher molecular-weight condensates. The goal is to reduce the degree of functionality of the alkoxy methyl derivatives and thus reduce the condensation volatiles, and to increase the T_{g} to improve storage and handling characteristics.

The retention of gloss on exterior exposure for the urethane polyesters is quite similar to coatings based on TGIC-cured polyesters. In addition to the polymeric backbone of the resin itself, exterior durability is influenced by formulating variables, such as the gloss control system used and color.

A special class of coating powders is based on unsaturated polyester resins. They are utilized in matched metal die molding operations such as sheet molding compounds (SMC) and bulk molding compounds (BMC) molding, where the mold is coated with the powder prior to placing the resin charge in the mold. The powder melts and flows on the mold surface, and when the mold is closed, the powder reacts with the molding compound forming a coating on the molded part. This process is generally known as in-mold coating. Unsaturated polyester resin powders can provide a colored and finished exterior molded surface or a finish ready for painting. In addition to the unsaturated polyester resin, multifunctional unsaturated monomers such as tdallyl cyanurate (TAC) or diallyl phthalate (DAP), suitable peroxide initiators or mixtures thereof, and mold release agents are used to formulate the coating powder.

Coating powders based on acrylic resins have been available in both Europe and the United States since the early 1970s, but have never achieved significant commercial success. The development of acrylic coating powders for automotive topcoats, where acrylic resins have a long history of successful performance, is being pursued. Among the obstacles to the acceptance of powder coatings for automotive topcoats is the inability to change colors rapidly and economically. Acrylic-based clear coats are being developed.

Acrylic coating powders have achieved some success in. Japan utilizing resins having methylacrylate functionality cured with C₁₀-C₁₂ dicarboxylic acids. Hybrid polyester-acrylic coating powders have also been reported in which an acid functional polyester resin coreacts with a glycidyl-containing acrylic polymer. Hydroxyl functional acrylic resins cured with blocked isocyanates have also been available for many years in the United States and achieved some commercial success as appliance finishes.

The powder coatings for use in the present invention multi-layer coating system may be applied by a variety of techniques. Typically, such coatings are applied by spray coating, immersion or exposure to a fluidized bed, or by electrostatic spray strategies. For certain thermoplastic powder coatings, flame spray techniques can be used.

Although the present invention coating system has been described as preferably comprising a corrosion inhibiting underlayer and a powder coat top layer disposed on the underlayer, it will be understood that the invention encompasses the use of one or more additional layers at any location(s) within the resulting system. For example, the present invention coating system includes the use of a layer of another agent or material between the substrate to be coated and the corrosion inhibiting layer, between the corrosion inhibiting layer and the powder coat layer, and/or disposed on the powder coat layer. Moreover, it is further contemplated that the present invention coating system includes the use of multiple layers of either or both the corrosion inhibiting material and the powder coat material. Furthermore, it is envisioned that the present invention includes coating systems in which other types of coatings or layers are used.

A wide array of industrial parts and components may receive the multi-layer coating system of the present invention. Vehicle components are particularly well suited for being coated as described herein. Vehicle accessories such as towing assemblies are also preferred candidates for the present invention.

### Testing

A series of trials were conducted in which various metal panels were coated with various coating systems according to the present invention and were compared with other coated panels.

Test panels and parts were coated with either Dacromet® or Geomet® and then a clear coat was applied as noted below in Table 4. In this first set of trials, various parameters and combinations of materials were varied to identify improved adhesion quality of the coating system to the metal substrate. All metal panels were alkaline rubbed, scrubbed, rinsed and dried prior to application of the Dacromet® or Geomet® coatings. Coating weight and thickness for both types of coatings are set forth below in Table 4.

Specifically, half of the metal panels were coated with Dacromet® 320 LV. The remaining metal panels were coated with a layer of Geomet®. A coating of clear coat was applied to 13 of the Dacromet® 320 LV coated panels. And, a coating of clear coat was applied to 13 of the Geomet® coated panels. Application and curing parameters were as follows.

Geomet® was applied to panels at 2 inches per minute draw and at 65° C. (150° F.) for 10 minutes. Curing was performed at 315° C. (600° F.) for 30 minutes. The 320 LV was applied to panels at 4 inches per minute draw and at 65° C. (150° F.) for 10 minutes. Curing was performed at 315° C. (600° F.) for 20 minutes. MRP topcoat was applied to all panels at 2 inches per minute draw and at 177° C. (350° F.) for 15 minutes.

TABLE 4
Coating Thickness and Weight

| | | Basecoat | |
|---|---|---|---|
| | Basecoat/Coating | Thickness | Clearcoat Coating |
| Panel | Weight (g/m²) | (microns) | Weight (g/m²) |
| 1 | Geomet ®/25.7 | 8.1 | N/A |
| 2 | Geomet ®/27.6 | 8.7 | N/A |
| 3 | Geomet ®/26.7 | 8.4 | N/A |
| 4 | Geomet ®/26.9 | 8.4 | N/A |
| 5 | Geomet ®/26.2 | 8.2 | N/A |
| 6 | Geomet ®/24.7 | 7.7 | N/A |
| 7 | Geomet ®/25 | 7.8 | N/A |
| 8 | Geomet ®/25.9 | 8.1 | N/A |
| 9 | Geomet ®/24.5 | 7.7 | N/A |
| 10 | Geomet ®/25 | 7.8 | N/A |
| 11 | Geomet ®/23.8 | 7.5 | 4.6 |
| 12 | Geomet ®/24.7 | 7.7 | N/A |
| 13 | Geomet ®/24.2 | 7.6 | N/A |
| 14 | Geomet ®/23.8 | 7.5 | 3.6 |
| 15 | Geomet ®/23 | 7.2 | 3.9 |
| 16 | Geomet ®/22.6 | 7.1 | 3.9 |
| 17 | Geomet ®/23.3 | 7.3 | 3.6 |
| 18 | Geomet ®/22.8 | 7.1 | 4.6 |
| 19 | Geomet ®/22.1 | 6.5 | 4.8 |
| 20 | Geomet ®/22.1 | 7.1 | 4.6 |
| 21 | Geomet ®/22.1 | 6.9 | 3.9 |
| 22 | Geomet ®/22.1 | 6.9 | 4.1 |
| 23 | Geomet ®/22.1 | 6.9 | 3.9 |
| 24 | Geomet ®/22.1 | 6.9 | 4.1 |
| 25 | Geomet ®/21.8 | 6.8 | 4.1 |
| 26 | 320LV/17.0 | 4.7 | 5.6 |
| 27 | 320LV/17.5 | 4.9 | N/A |
| 28 | 320LV/17.0 | 4.7 | N/A |
| 29 | 320LV/17.0 | 4.7 | N/A |
| 30 | 320LV/17.5 | 4.9 | N/A |
| 31 | 320LV/17.2 | 4.8 | N/A |
| 32 | 320LV/17.2 | 4.8 | 5.3 |
| 33 | 320LV/17.2 | 4.8 | 5.6 |
| 34 | 320LV/17.2 | 4.8 | 5.6 |
| 35 | 320LV/17.0 | 4.7 | 5.8 |
| 36 | 320LV/17.2 | 4.8 | N/A |
| 37 | 320LV/16.7 | 4.7 | N/A |
| 38 | 320LV/17.0 | 4.7 | 5.6 |
| 39 | 320LV/16.7 | 4.7 | 5.3 |
| 40 | 320LV/17.0 | 4.7 | 5.1 |
| 41 | 320LV/17.0 | 4.7 | N/A |
| 42 | 320LV/17.0 | 4.7 | N/A |
| 43 | 320LV/17.0 | 4.7 | N/A |
| 44 | 320LV/17.2 | 4.8 | 5.1 |
| 45 | 320LV/17.0 | 4.7 | 4.8 |
| 46 | 320LV/17.0 | 4.7 | 5.1 |
| 47 | 320LV/16.5 | 4.6 | 5.1 |
| 48 | 320LV/16.5 | 4.6 | 4.8 |
| 49 | 320LV/16.7 | 4.7 | N/A |
| 50 | 320LV/16.5 | 4.6 | N/A |

Various grades of powder coat were applied to the previously described coated panels. All powder coat compositions were obtained from Ferro Corporation, Cleveland, Ohio, under the following designations:

| | |
|---|---|
| VP-346 | low gloss black polyester |
| VP-1389 | high gloss black polyester |
| 6B123 | high gloss black polyester |
| VE-309 | high gloss black epoxy |
| VE-1383-F | medium gloss black epoxy |
| VA-2345 | high gloss black acrylic |

These are all exterior grade and underbody grade powder coat compositions.

After coating and appropriate drying and curing, described below in Table 5, the resulting coating systems were subjected to adhesion testing in accordance with ASTM D-3359, Method B. The various coated panels were compared with panels coated with the commercially available Bonderite® phosphate coating.

TABLE 5
Geomet ® & Dacromet ® 320LV Substrates
Adhesion of Automotive Powder Coatings

| Powder | Panel | | | Film | Coating | Adhesion¹ |
|---|---|---|---|---|---|---|
| Coating | No. | Substrate Type | Pre-Bake | Thickness(mils) | Gassing | Rating |
| VP-346 | | Bonderite | None | 2.7-2.8 | None | 5B |
| VP-346 | 30 | Dacromet ® 320LV | None | 2.5-2.7 | None | 0B |
| VP-346 | 5 | Geomet ® | None | 2.7-2.7 | None | 4B |
| VP-346 | 47 | Dacromet ® 320LV + Clear | None | 2.7-2.8 | None | 0B |
| VP-346 | 15 | Geomet ® + Clear | None | 2.6-2.8 | None | 1B |
| VP-1389 | | Bonderite 1000 | None | 2.4-2.6 | None | 5B |
| VP-1389 | 29 | Dacromet ® 320LV | 5′ @ 375° F. | 2.4-2.6 | Slight | 4B |
| VP-1389 | 3 | Geomet ® | 5′ @ 375° F. | 2.5-2.7 | Moderate | 5B |
| VP-1389 | 26 | Dacromet ® 320LV + Clear | 5′ @ 375° F. | 2.5-2.7 | Slight | 1B |
| VP-1389 | 16 | Geomet ® + Clear | 5′ @ 375° F. | 2.5-2.6 | Slight | 5B |
| 6B123 | | Bonderite 1000 | None | 2.5-2.6 | None | 5B |
| 6B123 | 36 | Dacromet ® 320LV | 5′ @ 375° F. | 2.7-2.7 | None | 1B |
| 6B123 | 4 | Geomet ® | 5′ @ 375° F. | 2.5-2.7 | Moderate | 5B |
| 6B123 | 40 | Dacromet ® 320LV + Clear | 5′ @ 375° F. | 2.6-2.8 | Moderate | 0B |
| 6B123 | 20 | Geomet ® + Clear | 5′ @ 375° F. | 2.6-2.7 | Moderate | 4B |
| VE-309 | | Bonderite 1000 | None | 2.7-2.8 | None | 5B |
| VE-309 | 43 | Dacromet ® 320LV | None | 2.7-2.9 | Slight | 0B |
| VE-309 | 1 | Geomet ® | None | 2.7-2.8 | Moderate | 5B |
| VE-309 | 38 | Dacromet ® 320LV + Clear | None | 2.8-2.8 | Severe | 0B |
| VE-309 | 21 | Geomet ® + Clear | None | 2.7-2.8 | Moderate | 0B |
| VE-1383-F | | Bonderite 1000 | None | 2.7-3.0 | None | 5B |
| VE-1383-F | 42 | Dacromet ® 320LV | 5′ @ 375° F. | 2.6-2.8 | Slight | 0B |
| VE-1383-F | 9 | Geomet ® | 5′ @ 375° F. | 2.8-2.9 | Moderate | 3B |
| VE-1383-F | 46 | Dacromet ® 320LV + Clear | 5′ @ 375 ° F. | 2.4-2.8 | Slight | 0B |
| VE-1383-F | 24 | Geomet ® + Clear | 5′ @ 375° F. | 2.7-2.8 | Slight | 0B |
| VA-2345 | | Bonderite 1000 | None | 2.5-2.7 | None | 5B |
| VA-2345 | 50 | Dacromet ® 320LV | 5′ @ 375° F. | 2.5-2.7 | Slight | 0B |
| VA-2345 | 12 | Geomet ® | 5′ @ 375° F. | 2.5-2.6 | Moderate | 1B |
| VA-2345 | 44 | Dacromet ® 320LV + Clear | 5′ @ 375° F. | 2.6-2.7 | Slight | 0B |
| VA-2345 | 18 | Geomet ® + Clear | 5′ @ 375° F. | 2.5-2.8 | Slight | 1B |

Notes
¹ASTM D-3359 Method B
5B = 0% 4B =< 5% 3B = 5-15% 2B = 15-35% 1B = 35-65% 0B => 65% (Adhesion Loss)

Failure mode is somewhat difficult to discern but most adhesion loss appears to be to steel. Pre-baking of Geomet® and Dacromet® substrates was started after severe gassing with VE-309. Epoxy coatings were cured for 15 minutes at 149° C. (300° F.), all other coatings cured for 15 minutes at 190° C. (375° F.).

Generally, the panels according to the present invention exhibited superior performance over panels coated with the commercially available Bonderite® phosphate coating.

The foregoing description is, at present, considered to be the preferred embodiments of the present invention. However, it is contemplated that various changes and modifications apparent to those skilled in the art, may be made without departing from the present invention. Therefore, the foregoing description is intended to cover all such changes and modifications encompassed within the spirit and scope of the present invention, including all equivalent aspects.

We claim:

1. An anti-corrosion coating system comprising:
a first layer formed from a corrosion inhibiting composition comprising particulate metal, organic liquid, thickener, and a silane binding agent; and
a second layer disposed on said first layer, said second layer formed from a powder coat composition.

2. The anti-corrosion coating system of claim 1 wherein said particulate metal is selected from the group consisting of finely divided aluminum, manganese, cadmium, nickel, stainless steel, tin, ferroalloys, magnesium, zinc, and combinations thereof.

3. The anti-corrosion coating of claim 2 wherein said particulate metal is zinc.

4. The anti-corrosion coating system of claim 1, wherein said powder coat composition comprises a thermoplastic resin.

5. The anti-corrosion coating system of claim 4, wherein said thermoplastic resin is selected from the group consisting of polyvinyl chlorides, polyamides, polyethylenes, polypropylenes, poly(vinylidene) fluorides, and combinations thereof.

6. The anti-corrosion coating system of claim 1, wherein said powder coat composition comprises a thermoset resin.

7. The anti-corrosion coating system of claim 6, wherein said thermoset resin is selected from the group consisting of epoxies, epoxy-polyesters, polyester-TGIC's, urethane polyesters, unsaturated polyesters, acrylics, and combinations thereof.

8. An anti-corrosion coating system comprising:
a first layer formed from a composition including zinc flakes and aluminum flakes dispersed in a binder; and
a second layer disposed on said first layer, said second layer formed from a powder coat composition.

9. The anti-corrosion coating system of claim 8, wherein said powder coat composition comprises a thermoplastic resin.

10. The anti-corrosion coating system of claim 9, wherein said thermoplastic resin is selected from the group consisting of polyvinyl chlorides, polyamides, polyethylenes, polypropylenes, poly(vinylidene) fluorides, and combinations thereof.

11. The anti-corrosion coating system of claim 8, wherein said powder coat composition comprises a thermoset resin.

12. The anti-corrosion coating system of claim 11, wherein said thermoset resin is selected from the group consisting of epoxies, epoxy-polyesters, polyester-TGIC's, urethane polyesters, unsaturated polyesters, acrylics, and combinations thereof.

13. An anti-corrosion coating system comprising:
a first layer formed from a composition comprising zinc alloy in particulate form comprising greater than 50 weight percent zinc and less than 50 weight percent of non-zinc alloy metal; and
a second layer disposed on said first layer, said second layer formed from a powder coat composition.

14. The coating system of claim 13 wherein said zinc alloy is in flake form and is zinc alloyed with at least one metal selected from the group consisting of aluminum, tin, magnesium, nickel, cobalt, manganese, and combinations thereof.

15. The anti-corrosion coating system of claim 13, wherein said powder coat composition comprises a thermoplastic resin.

16. The anti-corrosion coating system of claim 15, wherein said thermoplastic resin is selected from the group consisting of polyvinyl chlorides, polyamides, polyethylenes, polypropylenes, poly(vinylidene) fluorides, and combinations thereof.

17. The anti-corrosion coating system of claim 13, wherein said powder coat composition comprises a thermoset resin.

18. The anti-corrosion coating system of claim 17, wherein said thermoset resin is selected from the group consisting of epoxies, epoxy-polyesters, polyester-TGIC's, urethane polyesters, unsaturated polyesters, acrylics, and combinations thereof.

19. An anti-corrosion coating system comprising:
a first layer formed from a composition comprising (A) liquid medium, (B) zinc alloy in particulate form comprising greater than 50 weight percent zinc and less than 50 weight percent of non-zinc alloy metal and (C) silane binding agent; and
a second layer disposed on said first layer, said second layer formed from a powder coat composition.

20. The coating system of claim 19 wherein said zinc alloy is in flake form and is zinc alloyed with at least one metal selected from the group consisting of aluminum, tin, magnesium, nickel, cobalt, manganese, and combinations thereof.

21. The anti-corrosion coating system of claim 19, wherein said powder coat composition comprises a thermoplastic resin.

22. The anti-corrosion coating system of claim 21, wherein said thermoplastic resin is selected from the group consisting of polyvinyl chlorides, polyamides, polyethylenes, polypropylenes, poly(vinylidene) fluorides, and combinations thereof.

23. The anti-corrosion coating system of claim 19, wherein said powder coat composition comprises a thermoset resin.

24. The anti-corrosion coating system of claim 23, wherein said thermoset resin is selected from the group consisting of epoxies, epoxy-polyesters, polyester-TGIC's, urethane polyesters, unsaturated polyesters, acrylics, and combinations thereof.

25. An anti-corrosion coating system comprising:
a first layer formed from a composition comprising (A) liquid medium, (B) zinc alloy in particulate form comprising greater than 50 weight percent zinc and less than 50 weight percent of non-zinc alloy metal, and (C) one or more of a water-soluble and water dispersible silica substance; and
a second layer disposed on said first layer, said second layer formed from a powder coat composition.

26. The coating system of claim 25 wherein said zinc alloy is in flake form and is zinc alloyed with at least one metal selected from the group consisting of aluminum, tin, magnesium, nickel, cobalt, manganese, and combinations thereof.

27. The anti-corrosion coating system of claim 25, wherein said powder coat composition comprises a thermoplastic resin.

28. The anti-corrosion coating system of claim 27, wherein said thermoplastic resin is selected from the group consisting of polyvinyl chlorides, polyamides, polyethylenes, polypropylenes, poly(vinylidene) fluorides, and combinations thereof.

29. The anti-corrosion coating system of claim 25 wherein said powder coat composition comprises a thermoset resin.

30. The anti-corrosion coating system of claim 29, wherein said thermoset resin is selected from the group consisting of epoxies, epoxy-polyesters, polyester-TGIC's, urethane polyesters, unsaturated polyesters, acrylics, and combinations thereof.
